(19) United States
(12) Patent Application Publication
(10) Pub. No.: US 2015/0093542 A1
(43) Pub. Date: Apr. 2, 2015

(54) CARRIER FILM FOR TRANSPARENT CONDUCTIVE FILMS, AND LAMINATE

(71) Applicant: NITTO DENKO CORPORATION, Ibaraki-shi, Osaka (JP)

(72) Inventors: Masamichi Matsumoto, Ibaraki-shi (JP); Ikkou Hanaki, Ibaraki-shi (JP); Kenta Yamashita, Ibaraki-shi (JP)

(73) Assignee: NITTO DENKO CORPORATION, Ibaraki-shi, Osaka (JP)

(21) Appl. No.: 14/366,461

(22) PCT Filed: Dec. 14, 2012
(86) PCT No.: PCT/JP2012/082548

§ 371 Date: Jun. 18, 2014

(30) Foreign Application Priority Data
Dec. 19, 2011 (JP) 2011-277342
Apr. 27, 2012 (JP) 2012-102822
Dec. 7, 2012 (JP) 2012-268625

(51) Int. Cl. C09J 7/02; B32B 7/12

(52) U.S. Cl. CPC C09J 7/0217; B32B 7/12
USPC 428/142; 428/141

(57) ABSTRACT

A carrier film for transparent conductive films, including: a support; and a pressure-sensitive adhesive layer provided on at least one side of the support, wherein the pressure-sensitive adhesive layer has an adhesive surface with an arithmetic mean surface waviness Wa of 70 nm or less opposite to an adhesive surface in contact with the support.

### TECHNICAL FIELD

The invention relates to a carrier film for transparent conductive films. The carrier film includes a support and a pressure-sensitive adhesive layer having a specific arithmetic mean surface waviness. The invention also relates to a laminate including a transparent conductive film and the carrier film for transparent conductive films.

### BACKGROUND ART

In touch panels, liquid crystal display panels, organic EL panels, electrochromic panels, electronic paper elements and the like, demands for elements using a film substrate obtained by providing a transparent electrode on a plastic film have recently been increasing.

An ITO thin film (In—Sn composite oxide) is now mainly used as a material of a transparent electrode, and a thickness of a thin film substrate including the above ITO thin film tends to become thin year by year.

Under these circumstances, a surface protective film or the like is used in the state of being bonded to an optical member such as an ITO thin film in processing step, transporting step or the like for the purpose of preventing scratches, stains and the like. For example, Patent Document 1 discloses that a thin surface protective film is used in the state of being bonded to an optical member.

The thin film substrate including the above ITO thin film, often has an anti-reflection (AR) film as a functional layer for improving visibility or a hard coating (HC) film as a functional layer for protecting it from scratches.

### PRIOR ART DOCUMENTS

### Patent Documents

Patent Document 1: JP-A-2007-304317

### SUMMARY OF THE INVENTION

### Problems to be Solved by the Invention

For higher productivity, however, the functional layer-bearing substrate is typically subjected to a manufacturing process such as a process of forming or patterning the ITO thin film. In this case, the functional layer-bearing transparent conductive film is placed in a heated environment or washed with water, so that it can be exposed to great changes in temperature. There is a problem in that such temperature changes cause the transparent conductive film (or the functional layer itself when the transparent conductive film has the functional layer) to undergo significant deformation (such as waviness).

It is therefore an object of the invention to provide a carrier film for transparent conductive films, which can prevent, by being bonded to the transparent conductive film, the deformation of the transparent conductive film (or the deformation of a functional layer in cases where the transparent conductive film has the functional layer) even when the transparent conductive film having a transparent conductive layer such as an ITO thin film is subjected to a manufacturing process accompanied by temperature changes, a transporting process, or other processes. It is another object of the invention to provide a carrier film for transparent conductive films, which can preserve the geometry of the transparent conductive film without causing the transparent conductive film as an adherend to be wrinkled, scratched, or damaged in other ways. It is a further object of the invention to provide a laminate including such a carrier film and a transparent conductive film.

### Means for Solving the Problems

The present inventors have intensively studied so as to achieve the above object and found that the above object can be achieved by using the carrier film for transparent conductive films of the invention, and thus the present invention has been completed.

A carrier film for transparent conductive films of the invention comprises:

a support; and

a pressure-sensitive adhesive layer provided on at least one side of the support,

wherein the pressure-sensitive adhesive layer has an adhesive surface with an arithmetic mean surface waviness Wa of 70 nm or less opposite to an adhesive surface in contact with the support. The carrier film of the invention can be used on a transparent conductive film including a support and a transparent conductive layer. When the carrier film of the invention is used, the pressure-sensitive adhesive layer of the carrier film can be bonded to the surface of the support of the transparent conductive film opposite to its surface on which the transparent conductive layer is provided (or can be bonded to a functional layer when the transparent conductive film further includes the functional layer on the surface of the support).

In the carrier film of the invention, the pressure-sensitive adhesive layer is made from a pressure-sensitive adhesive composition containing a base polymer and a crosslinking agent.

In the carrier film of the invention, the base polymer is preferably a (meth)acrylic polymer, and the pressure-sensitive adhesive composition preferably contains more than 10 parts by weight of the crosslinking agent based on 100 parts by weight of the (meth)acrylic polymer.

In the carrier film of the invention, the base polymer is preferably a (meth)acrylic polymer obtained by polymerization of a monomer component containing a (meth)acrylic ester having an alkyl group of 2 to 14 carbon atoms and a functional group-containing monomer.

In the carrier film of the invention, the pressure-sensitive adhesive composition preferably has a molar ratio of a functional group of the crosslinking agent to a functional group of the functional group-containing monomer of 0.70 or more.

In the carrier film of the invention, the (meth)acrylic ester preferably includes butyl (meth)acrylate.

The present invention relates to a laminate, comprising:

a carrier film for transparent conductive films; and

a transparent conductive film placed on the carrier film,

wherein

the carrier film is a carrier film of the invention,

the transparent conductive film comprises a support and a transparent conductive layer, and

an adhesive surface of the pressure-sensitive adhesive layer of the carrier film is bonded to a surface of the support opposite to a surface of the support in contact with the transparent conductive layer.

The present invention also relates to a laminate, comprising:

a carrier film for transparent conductive films; and

a transparent conductive film placed on the carrier film,

wherein

the carrier film is a carrier film of the invention,

the transparent conductive film comprises a support, a transparent conductive layer, and a functional layer provided on a surface of the support opposite to a surface of the support in contact with the transparent conductive layer, and

an adhesive surface of the pressure-sensitive adhesive layer of the carrier film is bonded to a surface of the functional layer opposite to a surface of the functional layer in contact with the support.

The laminate of the invention preferably has a ratio of Wa after bonding to Wa before bonding of 0.5 to 3.0, wherein Wa after bonding represents the arithmetic mean surface waviness of a surface of the functional layer of the transparent conductive film after the surface is brought into contact with and bonded to the adhesive surface of the pressure-sensitive adhesive layer of the carrier film, and Wa before bonding represents the arithmetic mean surface waviness of the surface of the functional layer of the transparent conductive film before the surface is brought into contact with and bonded to the adhesive surface of the pressure-sensitive adhesive layer of the carrier film.

### Effect of the Invention

The carrier film of the invention including the support and the pressure-sensitive adhesive layer having the specified arithmetic mean surface waviness can prevent, by being bonded to a transparent conductive film, the deformation of the transparent conductive film (or the deformation of a functional layer in cases where the transparent conductive film has the functional layer) even when the transparent conductive film is subjected to a manufacturing process accompanied by temperature changes, such as heating or washing with water, a transporting process, or other processes. When used on a transparent conductive film, the carrier film of the invention can also preserve the geometry of the transparent conductive film without causing the transparent conductive film as an adherend to be wrinkled, scratched, or damaged in other ways.

### BRIEF DESCRIPTION OF THE DRAWINGS

FIG. 1(a) is a schematic diagram of a laminate including: a carrier film having a pressure-sensitive adhesive layer; and a functional layer-bearing transparent conductive film bonded to the surface of the pressure-sensitive adhesive layer; and

FIG. 1 (b) is a schematic diagram of a laminate including: a carrier film having a pressure-sensitive adhesive layer; and a transparent conductive film bonded to the surface of the pressure-sensitive adhesive layer.

### MODE FOR CARRYING OUT THE INVENTION

### 1. Carrier Film for Transparent Conductive Films

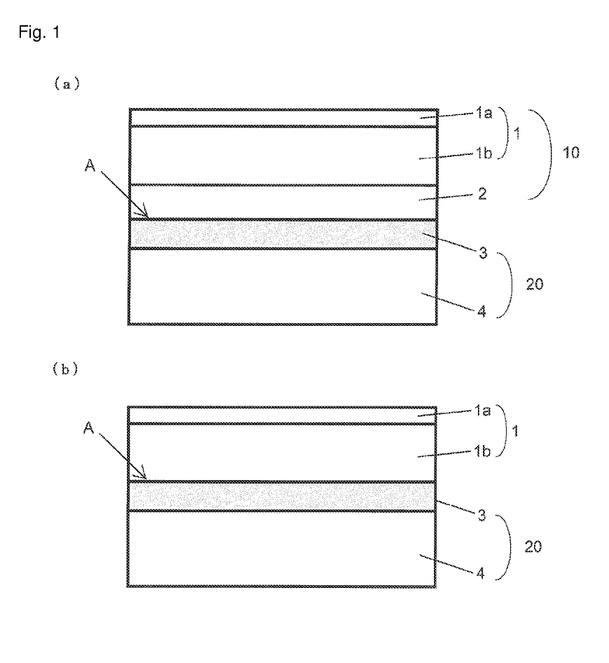

Hereinafter, embodiments of the invention will be described with reference to FIG. 1. It will be understood that the embodiments shown in FIG. 1 is not intended to limit the invention.

A carrier film 20 of the invention for transparent conductive films includes a support 4 and a pressure-sensitive adhesive layer 3 provided on at least one side of the support 4. The pressure-sensitive adhesive layer 3 has an adhesive surface A with an arithmetic mean surface waviness Wa of 70 nm or less opposite to an adhesive surface in contact with the support. The arithmetic mean surface waviness Wa of the adhesive surface A of the pressure-sensitive adhesive layer 3, which is opposite to an adhesive surface in contact with the support, means a relatively large waviness of the surface of the pressure-sensitive adhesive layer 3. The surface waviness is an indicator, which differs from the indicator generally called arithmetic mean surface roughness Ra. As shown in FIG. 1(a), a functional layer-bearing transparent conductive film 10 may be provided, which has a functional layer 2. In this case, the adhesive surface A is in contact with the functional layer 2. As shown in FIG. 1(b), a transparent conductive film 1 with no functional layer may also be provided. In this case, the transparent conductive film 1 includes a transparent conductive layer 1a and a support 1b, and the adhesive surface A is in contact with the surface of the support (base material) 1b (or in contact with the side of the support 1b opposite to its side on which the transparent conductive layer 1a is provided).

### (1) Pressure-Sensitive Adhesive Layer

In the invention, the pressure-sensitive adhesive layer is preferably made from a pressure-sensitive adhesive composition containing a base polymer and a crosslinking agent. The pressure-sensitive adhesive composition may include an acrylic pressure-sensitive adhesive, a synthetic rubber-based pressure-sensitive adhesive, a rubber-based pressure-sensitive adhesive, a silicone-based pressure-sensitive adhesive, or other pressure-sensitive adhesives. In view of transparency, heat resistance, and other properties, an acrylic pressure-sensitive adhesive containing a (meth)acrylic polymer as a base polymer is preferred.

The (meth)acrylic polymer as a base polymer for the acrylic pressure-sensitive adhesive is preferably obtained by polymerization of a monomer component containing a (meth)acrylic ester ((meth)acrylic monomer) having an alkyl group of 2 to 14 carbon atoms. The use of the (meth)acrylic ester is advantageous in view of easiness of handling and other properties.

The (meth)acrylic ester having an alkyl group of 2 to 14 carbon atoms, which may be used in the invention, is preferably a (meth)acrylic ester having an alkyl group of 4 to 14 carbon atoms. Examples of the (meth)acrylic ester having an alkyl group of 2 to 14 carbon atoms include ethyl (meth)acrylate, n-butyl (meth)acrylate (BA), tert-butyl (meth)acrylate, isobutyl (meth)acrylate, hexyl (meth)acrylate, 2-ethylhexyl (meth)acrylate (2EHA), n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, etc. These may be used singly or in combination of two or more. In particular, n-butyl (meth)acrylate (BA) and 2-ethylhexyl (meth)acrylate (2EHA) are preferably used, and n-butyl (meth)acrylate (BA) is more preferably used as a main monomer. In the invention, when n-butyl (meth)acrylate is used as a main monomer, the pressure-sensitive adhesive layer can be made less deformable before and after holding at increased temperature for crosslinking the pressure-sensitive adhesive layer of the carrier film, so that the arithmetic mean surface waviness Wa of the adhesive surface can be kept within the desired range before the pressure-sensitive adhesive layer is bonded to a transparent conductive film. In this aspect, the content of the main monomer is preferably 50% by weight or more, more preferably 60% by weight or more, even more preferably 80% by weight or more, further more preferably 100% by weight, based on the total weight of the “(meth)acrylic esters having an alkyl group of 2 to 14 carbon atoms” in the monomer components.

A blending amount of the (meth)acrylic monomer having an alkyl group of 2 to 14 carbon atoms is preferably 55% by weight or more, more preferably from 60 to 100% by weight, and still more preferably from 60 to 98% by weight, in the monomer components. Within the ranges, the arithmetic mean surface waviness Wa of the adhesive surface of the pressure-sensitive adhesive layer, which is opposite to its surface in contact with the support of the carrier film of the invention, can be easily controlled to be within a desired range, which is a preferred mode.

The monomer component may contain other polymerizable monomer other than the (meth)acrylic ester having an alkyl group of 2 to 14 carbon atoms. A polymerizable monomer or monomers for controlling the glass transition point or peeling property of the (meth)acrylic polymer may be used as the other polymerizable monomer as long as the effect of the invention is not impaired. Such monomers may be used singly or in any combination. The content of the other polymerizable monomer in the monomer component is preferably 45% by weight or less, more preferably 0 to 40% by weight.

It is possible to appropriately use, as the other polymerizable monomers, components for improving cohesive strength and heat resistance, such as a sulfonic acid group-containing monomer, a phosphoric acid group-containing monomer, a cyano group-containing monomer, a vinyl ester monomer and an aromatic vinyl monomer; and monomer components having a functional group serving as a cross-linking base point, such as a hydroxyl group-containing monomer, a carboxyl group-containing monomer, an acid anhydride group-containing monomer, an amide group-containing monomer, an amino group-containing monomer, an epoxy group-containing monomer, N-acryloyl morpholine and a vinylether monomer. These monomers may be used alone, or two or more kinds of them may be used in combination.

Examples of the carboxyl group-containing monomer include (meth)acrylic acid, carboxyethyl (meth)acrylate, carboxypentyl (meth)acrylate, itaconic acid, maleic acid, fumaric acid, crotonic acid and the like.

Examples of the acid anhydride group-containing monomer include maleic anhydride, itaconic anhydride and the like.

Examples of the hydroxyl group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutyl vinyl ether, diethylene glycol monovinyl ether and the like.

Examples of the sulfonic acid group-containing monomer include styrenesulfonic acid, allylsulfonic acid, 2-(meth)acrylamide-2-methylpropanesulfonic acid, (meth)acrylamidepropanesulfonic acid, sulfopropyl (meth)acrylate, (meth)acryloyloxynaphthalenesulfonic acid and the like.

Examples of the phosphoric acid group-containing monomer include 2-hydroxyethylacryloyl phosphate.

Examples of the cyano group-containing monomer include acrylonitrile and the like.

Examples of the vinyl ester monomer include vinyl acetate, vinyl propionate, vinyl laurate and the like.

Examples of the aromatic vinyl monomer include styrene, chlorostyrene, chloromethylstyrene, α-methylstyrene and the like.

Examples of the amide group-containing monomer include acrylamide, diethylacrylamide and the like.

Examples of the amino group-containing monomer include N,N-dimethylaminoethyl (meth)acrylate, N,N-dimethylaminopropyl (meth)acrylate and the like.

Examples of the epoxy group-containing monomer include glycidyl (meth)acrylate, allyl glycidyl ether and the like.

Examples of the vinyl ether monomer include methyl vinyl ether, ethyl vinyl ether, isobutyl vinyl ether and the like.

The (meth)acrylic polymer used in the invention can be obtained by polymerization of a monomer component. There is no particular limitation on a method for polymerizing the (meth)acrylic polymer. It is possible to polymerize the (meth)acrylic polymer by known methods such as solution polymerization, emulsion polymerization, bulk polymerization and suspension polymerization, and solution polymerization is more preferable from the viewpoints of workability and the like. The polymer to be obtained may be any of a homopolymer, a random copolymer, a block copolymer and the like.

The (meth)acrylic polymer to be used in the present invention preferably has a weight average molecular weight of 300,000 to 5,000,000, more preferably 400,000 to 4,000,000, and particularly preferably 500,000 to 3,000,000. In the case where the weight average molecular weight is less than 300,000, the adhesive power upon peeling increases due to an improvement in wettability to the (functional layer-bearing) transparent conductive film as an adherent, and therefore the adherend may be sometimes damaged in the peeling step (re-peeling), and further an adhesive residue tends to be generated due to small cohesive strength in the pressure-sensitive adhesive layer. On the other hand, in the case where the weight average molecular weight is more than 5,000,000, fluidity of the polymer decreases and wetting to the (functional layer-bearing) transparent conductive film as the adherend becomes insufficient, and thus blister may tend to be generated between the adherend and the carrier film for transparent conductive films. The weight average molecular weight refers to a weight average molecular weight obtained by measuring through gel permeation chromatography (GPC).

Since it is easy to keep a balance of adherability, the above (meth)acrylic polymer preferably has a glass transition temperature (Tg) of 0° C. or lower (usually −100° C. or higher, preferably −60° C. or higher), more preferably −10° C. or lower, still more preferably −20° C. or lower, and particularly preferably −30° C. or lower. In the case where the glass transition temperature is higher than 0° C., the polymer is less likely to flow and wetting to the (functional layer-bearing) transparent conductive film as the adherend becomes insufficient, and thus blister may tend to be generated between the adherend and the carrier film for transparent conductive films. The glass transition temperature (Tg) of the (meth)acrylic polymer can be adjusted within the above range by appropriately changing the monomer component to be used and the composition ratio.

The pressure-sensitive adhesive layer to be used in the present invention becomes excellent in heat resistance by appropriately adjusting a component unit of the (meth)acrylic polymer, a constituent ratio, selection of a cross-linking agent described below, a blend ratio and the like, and appropriately cross-linking the (meth)acrylic polymer.

It is possible to use, as the cross-linking agent in the present invention, an isocyanate compound, an epoxy compound, a melamine-based resin, an aziridine compound, a metal chelate compound and the like. Among these cross-linking agents, an isocyanate compound and an epoxy compound are used particularly preferably from the viewpoint of obtaining moderate cohesive strength. These compounds may be used alone, or two or more kinds of them may be used in combination.

Examples of the isocyanate compound include lower aliphatic polyisocyanates such as butylene diisocyanate and hexamethylene diisocyanate; alicyclic isocyanates such as cyclopentylene diisocyanate, cyclohexylene diisocyanate and isophorone diisocyanate; aromatic isocyanates such as 2,4-tolylene diisocyanate, 4,4′-diphenylmethane diisocyanate and xylylene diisocyanate; and isocyanate adducts such as a trimethylolpropane/tolylene diisocyanate trimer adduct (trade name: CORONATE L, manufactured by Nippon Polyurethane Industry Co., Ltd.), a trimethylolpropane/hexamethylene diisocyanate trimer adduct (trade name: CORONATE HL, manufactured by Nippon Polyurethane Industry Co., Ltd.) and an isocyanurate compound of hexamethylene diisocyanate (trade name: CORONATE HX, manufactured by Nippon Polyurethane Industry Co., Ltd.). These compounds may be used alone, or two or more kinds of them may be used in combination.

Examples of the epoxy compound include N,N,N′,N′-tetraglycidyl-m-xylenediamine (trade name: TETRAD-X, manufactured by MITSUBISHI GAS CHEMICAL COMPANY, INC.), 1,3-bis(N,N-diglycidylaminomethyl)cyclohexane (trade name: TETRAD-C, manufactured by MITSUBISHI GAS CHEMICAL COMPANY, INC.) and the like. These compounds may be used alone, or two or more kinds of them may be used in combination.

Examples of the melamine-based resin include hexamethylolmelamine and the like. Examples of the aziridine derivative include a commercially available product under the trade name of HDU (manufactured by Sogo Pharmaceutical Co., Ltd.), a commercially available product under the trade name of TAZM (manufactured by Sogo Pharmaceutical Co., Ltd.), a commercially available product under the trade name of TAZO (manufactured by Sogo Pharmaceutical Co., Ltd.) and the like. These compounds may be used alone, or two or more kinds of them may be used in combination.

Examples of the metal chelate compound include aluminum, iron, tin, titanium, nickel and the like as metal components; and acetylene, methyl acetoacetate, ethyl lactate and the like as chelate components. These compounds may be used alone, or two or more kinds of them may be used in combination.

In the invention, the crosslinking agent is preferably used in an amount of 1 part by weight or more, more preferably 2 parts by weight or more, even more preferably more than 10 parts by weight, based on 100 parts by weight (solid basis) of the (meth)acrylic polymer. The upper limit of the amount is preferably 30 parts by weight or less, more preferably 25 parts by weight or less. The use of the crosslinking agent in an amount of less than 1 part by weight may result in insufficient crosslink, so that the resulting pressure-sensitive adhesive layer may have low cohesive strength and insufficient heat resistance and tend to cause adhesive residue. On the other hand, if the amount exceeds 30 parts by weight, the resulting pressure-sensitive adhesive layer may have higher cohesive strength, lower fluidity, and insufficient wettability to a (functional layer-bearing) transparent conductive film as an adherend, which may tend to cause a blister between the pressure-sensitive adhesive layer and the adherend and therefore is not preferred. In the invention, when the crosslinking agent is added in an amount of more than 10 parts by weight, the pressure-sensitive adhesive layer can have an appropriate level of adhering strength and good removability no matter whether the carrier film of the invention is peeled off from a (functional layer-bearing) transparent conductive film (adherend) at a low peeling rate or a high peeling rate. These crosslinking agents may also be used singly or in combination of two or more.

The pressure-sensitive adhesive layer of the carrier film of the invention for transparent conductive films is preferably made from a pressure-sensitive adhesive composition containing a (meth)acrylic polymer and a crosslinking agent, in which the (meth)acrylic polymer is obtained by polymerization of a monomer component containing the (meth)acrylic ester having an alkyl group of 2 to 14 carbon atoms and the functional group-containing monomer. In this case, the functional group-containing monomer may have a functional group A, the crosslinking agent may have a functional group B capable of reacting with the functional group A, and the molar ratio (B/A) of the functional group B to the functional group A is preferably 0.70 or more, more preferably 0.75 or more, even more preferably from 0.8 to 0.95. For example, when a carboxyl group-containing monomer or monomers are used as a raw material or materials, the ratio of the “total number of moles of the functional groups B of all the crosslinking agents used, wherein the functional groups B are capable of reacting with the carboxyl group”, to the “total number of moles of the carboxyl groups A of all the carboxyl group-containing monomers used as raw materials” (the molar ratio of the functional group B capable of reacting with the carboxyl group to the carboxyl group A) is preferably 0.70 or more, more preferably 0.75 or more, even more preferably from 0.8 to 0.9. When the “molar ratio of the functional group capable of reacting with the carboxyl group to the carboxyl group” is 0.70 or more, the softening of the pressure-sensitive adhesive layer of the carrier film can be prevented in the process of heating a laminate including a transparent conductive film and the carrier film for transparent conductive films. Therefore, the deformation of the support and the functional layer in the transparent conductive film can be prevented, so that the rate of change in the arithmetic mean surface waviness Wa of the support and the functional layer can be reduced to fall within a desired range. The preferred molar ratio is also advantageous in that the amount of the unreacted carboxyl group in the pressure-sensitive adhesive layer can be reduced and that an increase in peel strength (adhesive power) over time, which is caused by the interaction between the carboxyl group and the adherend, can be effectively prevented.

For example, when a crosslinking agent with a functional group equivalent of 110 (g/eq), wherein the functional group is capable of reacting with a carboxyl group, is added (or mixed) in an amount of 7 g, the number of moles of the functional group of the crosslinking agent, capable of reacting with the carboxyl group, can be typically calculated as follows.

The number of moles of the functional group of the crosslinking agent, capable of reacting with the carboxyl group=(the added amount of the crosslinking agent)/(the functional group equivalent)=7/110

For example, when an epoxy crosslinking agent with an epoxy equivalent of 110 (g/eq) is added (mixed) in an amount of 7 g, the number of moles of the epoxy group of the epoxy crosslinking agent can be typically calculated as follows.

The number of moles of the epoxy group of the epoxy crosslinking agent=(the added amount of the epoxy crosslinking agent)/(the epoxy equivalent)=7/110

In the invention, a polyfunctional monomer having two or more radiation-reactive unsaturated bonds may be added in combination with the crosslinking agent or independently as a crosslinking component. In such a case, a (meth)acrylic polymer is cross-linked by irradiation with radiation. Examples of the polyfunctional monomer having two or more radiation-reactive unsaturated bonds in a molecule include polyfunctional monomers having two or more radiation-reactive unsaturated bonds of one or two or more kinds which can be cross-linked (cured) by irradiation with radiation, such as a vinyl group, an acryloyl group, a methacryloyl group and a vinylbenzyl group. Generally, those having ten or less radiation-reactive unsaturated bonds are suitably used as the polyfunctional monomer. These compounds may be used alone, or two or more kinds of them may be used in combination.

Specific examples of the polyfunctional monomer include ethylene glycol di(meth)acrylate, diethylene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinyl benzene, N,N′-methylenebisacrylamide and the like.

A blending amount of the cross-linking agent to be used in the present invention is preferably from 1 to 30 parts by weight, and more preferably from 2 to 25 parts by weight, based on 100 parts by weight (solid content) of the (meth)acrylic polymer.

Examples of the radiation include ultraviolet rays, laser beams, α-rays, β-rays, γ-rays, X-rays, electron beams and the like, and ultraviolet rays are suitably used from the viewpoints of controllability, satisfactory handleability and costs. More preferably, ultraviolet rays having a wavelength of 200 to 400 nm are used. It is possible to irradiate ultraviolet rays using appropriate light sources such as a high-pressure mercury lamp, a microwave-excited type lamp and a chemical lamp. In the case of using ultraviolet rays as the radiation, a photopolymerization initiator is blended with a pressure-sensitive adhesive composition.

The photopolymerization initiator may be a substance which forms a radical or cation by irradiation with ultraviolet rays having an appropriate wavelength which can cause a polymerization reaction according to the kind of a radiation-reactive component.

Examples of the photoradical polymerization initiator include benzoins such as a benzoin, a benzoin methyl ether, a benzoin ethyl ether, an o-methylbenzoyl benzoate-p-benzoin ethyl ether, a benzoin isopropyl ether and α-methylbenzoin; acetophenones such as benzyl dimethyl ketal, trichloroacetophenone, 2,2-diethoxyacetophenone and 1-hydroxycyclohexyl phenyl ketone; propiophenones such as 2-hydroxy-2-methylpropiophenone and 2-hydroxy-4′-isopropyl-2-methylpropiophenone; benzophenones such as benzophenone, methylbenzophenone, p-chlorobenzophenone and p-dimethylaminobenzophenone; thioxanthones such as 2-chlorothioxanthone, 2-ethylthioxanthone and 2-isopropylthioxanthone; acylphosphine oxides such as bis(2,4,6-trimethylbenzoyl)-phenylphosphine oxide, 2,4,6-trimethylbenzoyldiphenylphosphine oxide and (2,4,6-trimethylbenzoyl)-(ethoxy)-phenylphosphine oxide; benzyl, dibenzosuberone, α-acyloxime ester and the like. These compounds may be used alone, or two or more kinds of them may be used in combination.

Examples of the photocation polymerization initiator include onium salts such as an aromatic diazonium salt, an aromatic iodonium salt and an aromatic sulfonium salt; organic metal complexes such as an iron-allene complex, a titanocene complex and an arylsilanol-aluminum complex; a nitrobenzyl ester, a sulfonic acid derivative, a phosphoric acid ester, a phenolsulfonic acid ester, diazonaphthoquinone and N-hydroxyimide sulfonate. These compounds may be used alone, or two or more kinds of them may be used in combination. The photopolymerization initiator is usually blended in an amount of 0.1 to 10 parts by weight, and preferably 0.2 to 7 parts by weight, based on 100 parts by weight of the (meth)acrylic polymer.

It is also possible to use in combination with auxiliary photopolymerization initiators such as amines. Examples of the auxiliary photopolymerization initiator include 2-dimethylaminoethyl benzoate, dimethylaminoacetophenone, ethyl p-dimethylaminobenzoate, isoamyl p-dimethylaminobenzoate and the like. These compounds may be used alone, or two or more kinds of them may be used in combination. The auxiliary photopolymerization initiator is preferably blended in an amount of 0.05 to 10 parts by weight, and more preferably 0.1 to 7 parts by weight, based on 100 parts by weight of the (meth)acrylic polymer.

The pressure-sensitive adhesive composition to be used in the present invention may contain other known additives. For example, it is possible to appropriately blend powders such as a colorant and a pigment, a surfactant, a plasticizer, a tackifier, a low-molecular weight polymer, a surface lubricant, a leveling agent, an antioxidant, a corrosion inhibitor, a photostabilizer, an ultraviolet absorber, a polymerization inhibitor, a silane coupling agent, an inorganic or organic filler, a metal powder, a granule and a foil-shaped substance according to the use applications.

The pressure-sensitive adhesive layer used in the invention, which can be made from the pressure-sensitive adhesive composition described above, is preferably obtained through the crosslinking reaction of the (meth)acrylic polymer with the crosslinking agent. The carrier film for a (functional layer-bearing) transparent conductive film of the present invention is obtained by forming such a pressure-sensitive adhesive layer on a support (base material, base material layer). In that case, (meth)acrylic polymer is generally cross-linked after applying the pressure-sensitive adhesive composition. It is also possible to transfer a pressure-sensitive adhesive layer made of the pressure-sensitive adhesive composition after cross-linking to a support and the like.

A non-limiting example of a method of forming the pressure-sensitive adhesive layer on the support (also referred to as the base material or the base material layer) includes applying the pressure-sensitive adhesive composition to the support (wherein, for example, the solid content of the coating is preferably 20% by weight or more, more preferably 30% by weight or more. A solid content of 20% by weight or more is preferable in that the arithmetic mean surface waviness Wa can be easily controlled to be within a desired range according to the invention) and removing the polymerization solvent and other materials by drying to form the pressure-sensitive adhesive layer on the support. Thereafter, aging may be performed for the purpose of adjusting transfer of the component of the pressure-sensitive adhesive layer and adjusting the cross-linking reaction. In the case of producing a carrier film for a transparent conductive film by applying the pressure-sensitive adhesive composition on the support, one or more kinds of solvents other than the polymerization solvent may be newly added to the pressure-sensitive adhesive composition so as to be uniformly applied on the support.

It is possible to use, as the method of applying a pressure-sensitive adhesive composition, a known method to be used in the production of a pressure-sensitive adhesive tape or the like. Specific examples thereof include roll coating, gravure coating, reverse coating, roll brushing, spray coating, and air knife coating methods and the like.

The drying conditions for the drying of the pressure-sensitive adhesive composition applied to the support may be appropriately determined depending on the components or concentration of the pressure-sensitive adhesive composition, the type of the solvent in the composition, or other factors. As a non-limiting example, the pressure-sensitive adhesive composition may be dried at 80 to 200° C. for about 10 seconds to about 30 minutes.

In the case of blending the photopolymerization initiator serving as an optional component mentioned above, the pressure-sensitive adhesive composition is applied on one or both surfaces of the support (base material, base material layer), and irradiated with light, and thus a pressure-sensitive adhesive layer can be obtained. Usually, a pressure-sensitive adhesive layer can be obtained by photopolymerization through irradiation with ultraviolet rays having an illuminance of 1 to 200 mW/cm² at a wavelength of 300 to 400 nm in a dose of about 400 to 4,000 mJ/cm².

In the carrier film of the invention for transparent conductive films, the pressure-sensitive adhesive layer preferably has a thickness of 5 to 50 μm, more preferably 10 to 30 μm. Within the ranges, a good balance between the adhesion and the removability can be achieved, which is a preferred mode. The pressure-sensitive adhesive layer is formed on at least one side of the support (base material layer) used in the invention by coating or other means to form a film, a sheet, a tape, or other shape.

The pressure-sensitive adhesive layer has an adhesive surface opposite to its surface in contact with the support. The adhesive surface of the pressure-sensitive adhesive layer has an arithmetic mean surface waviness Wa of 70 nm or less, preferably 65 nm or less, more preferably 60 nm or less, even more preferably from 1 to 55 nm. Within the ranges, the adhesive surface (tack surface) can be smooth, so that the transfer of any geometry from the adhesive surface to the adherend is less likely to occur, which is a preferred mode.

When the transparent conductive film has a functional layer, the pressure-sensitive adhesive layer of the carrier film of the invention may be bonded to the functional layer of the functional layer-bearing transparent conductive film. In this case, the ratio Wa1/Wa is preferably from 0.7 to 2.0, more preferably from 0.8 to 1.8, wherein Wa represents the arithmetic mean surface waviness of the adhesive surface of the pressure-sensitive adhesive layer before the adhesive surface is bonded to the functional layer, and Wa1 represents the arithmetic mean surface waviness of the adhesive surface of the pressure-sensitive adhesive layer after the adhesive surface is bonded to the functional layer. Within the ranges, the adhesive surface of the pressure-sensitive adhesive layer is prevented from being deformed during a heating process, so that the adhesive surface can be kept smooth during a manufacturing process, which is a preferred mode.

When the adhesive surface of the pressure-sensitive adhesive layer of the carrier film of the invention is bonded to the functional layer of the functional layer-bearing transparent conductive film, the ratio Wa_{F}1/Wa_{F} is preferably from 0.5 to 3.0, more preferably from 0.6 to 2.8, wherein the Wa_{F} represents the arithmetic mean surface waviness of the surface of the functional layer before the surface is brought into contact with and bonded to the adhesive surface, and Wa_{F}1 represents the arithmetic mean surface waviness of the surface of the functional layer after the surface is brought into contact with and bonded to the adhesive surface. Within the ranges, the adherend surface (functional layer surface) is not deformed even after heating, which is a preferred mode.

### (2) Support

The support (base material) (represented by numeral 4 in FIG. 1), which forms the carrier film of the invention for transparent conductive films, may be of any type. Examples of the support that may be used include a paper-based support such as a paper sheet; a fiber-based support such as a cloth, a nonwoven fabric, or a net (which may be made of any material, such as Manila hemp, rayon, polyester, or pulp fibers, which may be appropriately selected); a metal-based support such as a metal foil or a metal sheet; a plastic-based support such as a plastic film or sheet; a rubber-based support such as a rubber sheet; a foam material such as a foam sheet; a laminate of any combination thereof (such as a laminate of a plastic-based support and any other support or a laminate of plastic films (or sheets)); and other thin materials.

Examples of materials that may be used to form the plastic film or sheet include olefin resins including a monomer unit derived from an α-olefin, such as polyethylene (PE), polypropylene (PP), ethylene-propylene copolymers, and ethylene-vinyl acetate copolymers (EVA); polyester resins such as polyethylene terephthalate (PET), polyethylene naphthalate (PEN), and polybutylene terephthalate (PBT); polyvinyl chloride (PVC); vinyl acetate resins; polyphenylene sulfide (PPS); amide resins such as polyamide (nylon) and fully aromatic polyamide (aramid); polyimide resins; and polyether ether ketone (PEEK). These materials may be used singly or in combination of two or more. In particular, the polyester resins have strong toughness, processability and transparency. In a more preferred mode, therefore, any of the polyester resins are used to form the carrier film for transparent conductive films so that its ability to be handled or inspected can be improved.

There is no particular limitation on the polyester-based resin as long as it can be formed into a sheet, film or the like, and examples thereof include polyester films made of polyethylene terephthalate (PET), polyethylene naphthalate or polybutylene terephthalate. These polyester-based resins may be used alone (homopolymer), or two or more kinds of them may be used in combination after polymerization (copolymer, etc.). In the present invention, since the polyester-based resin is particularly used as the carrier film for a transparent conductive film, polyethylene terephthalate is preferably used as the material of the support. Therefore, when polyethylene terephthalate is used, the obtained carrier film for a transparent conductive film is excellent in strong toughness, processability and transparency and thus workability are improved, resulting in a preferred aspect.

The support preferably has a thickness of 75 to 200 μm, more preferably from 80 to 140 μm, and particularly preferably from 90 to 130 μm. When the thickness is within the above range, it is possible to retain a shape of the transparent conductive films which has no stiffness and is likely to be flexible by using the carrier film for a transparent conductive film in the state of bonding to the (functional layer-bearing) transparent conductive film, and generation of defects such as wrinkles and scratches in processing step, transporting step and the like can be prevented. Therefore, the carrier film for transparent conductive films is useful.

The support may be optionally subjected to a mold release treatment, an antifouling treatment and an acid treatment using a silicone-based, fluorine-based, long chain alkyl-based or fatty acid amide-based mold releasing agent, silica powder or the like; an easy adhesion treatment such as an alkali treatment, a primer treatment, a corona treatment, a plasma treatment or an ultraviolet treatment, and an electrostatic treatment such as a coating, kneading or vapor deposition treatment.

In order to improve adhesion between the pressure-sensitive adhesive layer and the support, a surface of the support may be subjected to a corona treatment or the like. The support may be subjected to a rear surface treatment.

It is possible to bond a separator on a surface of a pressure-sensitive adhesive layer of the carrier film for (functional layer-bearing) transparent conductive films of the present invention for the purpose of optionally protecting a pressure-sensitive adhesive surface. The base material constituting the separator includes paper and a plastic film, and a plastic film is suitably used from the viewpoint of excellent surface smoothness. There is no particular limitation on the film as long as it is a film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film and the like.

### 2. (Functional Layer-Bearing) Transparent Conductive Film

As shown in FIG. 1, the transparent conductive film (thin layer substrate) 1 may be a film including a transparent conductive layer 1a and a support 1b.

The support 1b may be a plastic film or a substrate made of glass or other materials (e.g., a substrate (component) in the form of a sheet, a film, or a plate). In particular, the support 1b should be a plastic film. The thickness of the support 1b is preferably, but not limited to, about 10 to about 200 μm, more preferably about 15 to about 150 μm.

The material for the plastic film may be, but not limited to, various transparent plastic materials. Examples of the material for the transparent plastic film include polyester resins such as polyethylene terephthalate and polyethylene naphthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyethersulfone resins are preferred.

The surface of the substrate 1b may be previously subject to sputtering, corona discharge treatment, flame treatment, ultraviolet irradiation, electron beam irradiation, chemical treatment, etching treatment such as oxidation, or undercoating treatment such that the adhesion of the transparent conductive layer 1a formed thereon to the substrate 1b can be improved. If necessary, the substrate 1b may also be subjected to dust removing or cleaning by solvent cleaning, ultrasonic cleaning or the like, before the transparent conductive layer 1a is formed.

The constituent material of the transparent conductive layer 1a is not particularly limited, and a metal oxide of at least one metal selected from the group consisting of indium, tin, zinc, gallium, antimony, titanium, silicon, zirconium, magnesium, aluminum, gold, silver, copper, palladium and tungsten is used. The metal oxide may further contain metal atoms shown in the above-mentioned group as necessary. For example, indium oxide (ITO) containing tin oxide, tin oxide containing antimony, and the like are preferably used, ITO is more preferably used. ITO preferably contains 80 to 99% by weight of indium oxide and 1 to 20% by weight of tin oxide.

The thickness of the transparent conductive layer 1a is preferably, but not limited to, from 10 to 300 nm, more preferably from 15 to 200 nm.

The transparent conductive layer 1a may be formed using known conventional methods, while the methods are not particularly limited. Examples of such methods include vacuum deposition, sputtering, and ion plating. Any appropriate method may be used depending on the required film thickness.

If desired, an undercoat layer, an oligomer blocking layer, or other layer may be provided between the transparent conductive layer 1a and the support 1b.

The transparent conductive film 1 having the transparent conductive layer 1a can be used as a substrate (optical member) for an optical device. There is no particular limitation on the substrate for an optical device, as long as it is a substrate having optical characteristics, and examples thereof include a substrate (member) constituting devices such as display devices (liquid crystal display devices, organic EL (electroluminescence) display devices, plasma display panels (PDPs), electronic paper, etc.) and input devices (touch panels, etc.) and a substrate (member) to be used in these devices. In recent years, such a substrate for an optical device has lost rigidity because of a trend toward a reduction in thickness. Thus, such a substrate for an optical device can be easily bent or deformed during a manufacturing process, a transporting process, or other processes. The carrier film of the invention may be bonded to such a substrate and used, so that the geometry of the substrate can be preserved and the occurrence of defects can be prevented, which is a preferred mode.

A functional layer 2 may be provided on the side of the transparent conductive film opposite to its side where the transparent conductive layer 1a is provided.

For example, an antiglare (AG) or anti-reflection (AR) layer for improving visibility may be provided as the functional layer. The material used to form the antiglare layer may be of any type such as ionizing radiation-curable resin, thermosetting resin, or thermoplastic resin. The antiglare layer preferably has a thickness of 0.1 to 30 μm. The anti-reflection layer may be made of titanium oxide, zirconium oxide, silicon oxide, magnesium fluoride, or other materials. The anti-reflection layer may be composed of two or more layers.

A hard coating (HC) layer may also be provided as the functional layer. The material used to form the hard coating layer is preferably a cured coating made from curable resin such melamine resin, urethane resin, alkyd resin, acrylic resin, or silicone resin. The hard coating layer preferably has a thickness of 0.1 to 30 μm. A thickness of 0.1 μm or more is preferred to impart hardness. The antiglare layer or the anti-reflection layer may also be provided on the hard coating layer.

The thickness of the functional layer-bearing transparent conductive film (including the thickness of the functional layer) is preferably 210 μm or less, more preferably 150 μm or less. When the carrier film of the invention is used on the (functional layer-bearing) transparent conductive film (adherend) with a thickness in the above range, the geometry of the transparent conductive film can be preserved even in a case where its thickness is very small, so that the occurrence of defects such as wrinkles or scratches can be prevented, which is a preferred mode.

The pressure-sensitive adhesive layer used in the invention preferably has an adhesive power of 0.1 to 3.5 N/20 mm, more preferably 0.2 to 2.5 N/20 mm, even more preferably 0.2 to 1.0N/20 mm, to the functional layer at any of a low peeling rate (0.3 m/minute) and a high peeling rate (10 m/minute) (which corresponds to the adhesive power to the surface A in FIG. 1 at room temperature (25° C.)). Within the ranges, the transparent conductive film can be prevented from undergoing deformation or other geometrical changes in the process of peeling off the carrier film from the transparent conductive film, which is a preferred mode. Specifically, if the adhesive power exceeds 3.0 N/20 mm, the transparent conductive film may tend to undergo deformation or other geometrical changes in the process of peeling off the carrier film from the transparent conductive film, which is not preferred.

### 3. Laminate

The present invention relates to a laminate, comprising:

a carrier film for transparent conductive films; and

a transparent conductive film placed on the carrier film,

wherein

the carrier film is a carrier film described in the description,

the transparent conductive film comprises a support and a transparent conductive layer, and

an adhesive surface of the pressure-sensitive adhesive layer of the carrier film is bonded to a surface of the support opposite to a surface of the support in contact with the transparent conductive layer.

The present invention relates to a laminate, comprising:

a carrier film for transparent conductive films; and

a transparent conductive film placed on the carrier film,

wherein

the carrier film is a carrier film described in the description,

the transparent conductive film comprises a support, a transparent conductive layer, and a functional layer provided on a surface of the support opposite to a surface of the support in contact with the transparent conductive layer, and

an adhesive surface of the pressure-sensitive adhesive layer of the carrier film is bonded to a surface of the functional layer opposite to a surface of the functional layer in contact with the support.

The laminate of the invention can be formed using the carrier film and the transparent conductive film described above.

When the adhesive surface of the pressure-sensitive adhesive layer of the carrier film is bonded to the functional layer of the functional layer-bearing transparent conductive film, the ratio Wa_{F}1/Wa_{F} is preferably from 0.5 to 3.0, more preferably from 0.6 to 2.8, wherein Wa_{F} represents the arithmetic mean surface waviness of the surface of the functional layer before the surface is brought into contact with and bonded to the adhesive surface, and Wa_{F}1 represents the arithmetic mean surface waviness of the surface of the functional layer after the surface is brought into contact with and bonded to the adhesive surface. Within the ranges, the functional layer surface is not deformed even after heating, which is a preferred mode.

### EXAMPLES

Examples and the like specifically illustrating the constitution and effect of the present invention will be descried below, but the present invention is not limited thereto. Evaluation items in Examples and the like were measured by the following procedures. The contents are shown in Tables 1 and 2, the evaluation results are shown in Table 3.

### Example 1

### Preparation of Acrylic Polymer (A)

In a four-necked flask equipped with a stirring blade, a thermometer, a nitrogen gas introducing tube and a condenser, 95 parts by weight of butyl acrylate (BA), 5 parts by weight of acrylic acid (AA), 0.2 parts by weight of 2,2′-azobisisobutyronitrile as a polymerization initiator and 234 parts by weight of ethyl acetate were charged and a nitrogen gas was introduced while stirring mildly. Then, a polymerization reaction was performed for about 7 hours while maintaining a liquid temperature inside the flask at about 63° C. to prepare an acrylic polymer (A) solution (30% by weight). The acrylic polymer (A) had a weight average molecular weight of 600,000 and a glass transition temperature (Tg) of −50° C.

### Preparation of Pressure-Sensitive Adhesive Solution

The above acrylic polymer (A) solution (30% by weight) was diluted with ethyl acetate to give a solution (20% by weight), and then 7 parts by weight of epoxy crosslinking agent (TETRAD-C manufactured by MITSUBISHI GAS CHEMICAL COMPANY, INC., T/C in Table 2) as a cross-linking agent was added based on 100 parts by weight (solid content) of the acrylic polymer of the solution. After mixing and stirring for about 1 minute while maintaining at about 25° C., an acrylic pressure-sensitive adhesive solution (1) was prepared.

### Production of Carrier Film for Transparent Conductive Film

The above acrylic pressure-sensitive adhesive solution (1) was applied on one surface of a polyethylene terephthalate (PET) base material (thickness: 125 μm, support) and then heated at 150° C. for 90 seconds to form a pressure-sensitive adhesive layer having a thickness of 20 μm. Then, the surface of the pressure-sensitive adhesive layer was bonded to the silicone-treated surface of a PET release liner (25 μm in thickness) whose one side was silicone-treated. The resulting laminate was stored at 50° C. for 2 days, so that a carrier film for transparent conductive films was obtained. The release liner was removed before the carrier film was used.

### Examples 2 to 4 and Comparative Example 1

Carrier films for transparent conductive films were prepared using the same process as in Example 1, except that the contents of the acrylic monomers used to form the acrylic polymer and the content of the crosslinking agent in the pressure-sensitive adhesive composition were changed as shown in Tables 1 and 2.

### Measurement of Weight Average Molecular Weight (Mw) of Acrylic Polymer

A weight average molecular weight of the produced polymer was measured by gel permeation chromatography (GPC).

Apparatus: HLC-8220GPC manufactured by TOSOH CORPORATION

### Column:

Sample column; TSKguardcolumn Super HZ-H (one column) and TSKgel Super HZM-H (two columns), manufactured by TOSOH CORPORATION
Reference column; TSKgel Super H-RC (one column), manufactured by TOSOH CORPORATION
Flow rate: 0.6 ml/minute
Injection amount: 10 μl
Column temperature: 40° C.

### Eluent: THF

Concentration of injected sample: 0.2% by weight
Detector: differential refractometer

The weight average molecular weight was calculated in terms of polystyrene.

### Measurement of Glass Transition Temperature (Tg)

A glass transition temperature Tg (° C.) was determined by the following equation using the following literature value as the glass transition temperature Tgn (° C.) of a homopolymer by each monomer.

1/(Tg+273)=Σ[Wn/(Tgn+273)] Equation:

wherein Tg (° C.) denotes a glass transition temperature of a copolymer, Wn (−) denotes a weight fraction of each monomer, Tgn (° C.) denotes a glass transition temperature of a homopolymer by each monomer, and n denotes a kind of each monomer.

2-ethylhexyl acrylate (2EHA): −70° C.

Butyl acrylate (BA): −55° C.

Acrylic acid: 106° C.

“Synthesis/Design and Development of New Application of Acrylic Resin” (published by Publishing Department of Chubu Management Development Center) was referred as the literature value.

### Arithmetic Mean Surface Waviness (Wa)

### Carrier Film for Transparent Conductive Films

(1) The pressure-sensitive adhesive layer of each carrier film for transparent conductive films had an “adhesive surface” opposite to its surface in contact with the support. An anti-reflection film (AR film) (product number: A-3504 manufactured by Nihon Ref-Lite Co., Ltd. (a film including a PET film and an anti-reflection layer provided thereon)) was provided. Before the carrier film for transparent conductive films was bonded to the AR film, the arithmetic mean surface waviness (Wa) of the adhesive surface and the Wa of the surface of the AR film (“AR surface”) were measured, respectively (the “Wa of the adhesive surface and the AR surface before the bonding of the AR film”).

(2) Subsequently, the “adhesive surface” of the carrier film was bonded to the “AR surface”. The carrier film was then peeled off from the AR film. After the peeling off, the arithmetic mean surface waviness (Wa) of the “adhesive surface” of the carrier film and the Wa of the “AR surface” were measured (the “Wa of the adhesive surface and the AR surface after the bonding of the AR film”).

Specifically, the sample was prepared by the following procedure. First, the Wa of the AR surface of the AR film and the Wa of the adhesive surface of the carrier film were each measured. The Wa of the AR surface and the Wa of the adhesive surface are called Wa_{AR} and Wa, respectively.

Subsequently, the adhesive surface of the pressure-sensitive adhesive layer of the carrier film was bonded to the AR film using a laminator (bonding pressure: 0.4 MPa, bonding speed: 2.0 m/minute). Subsequently, the resulting laminate was heated at 140° C. for 90 minutes and then allowed to stand at room temperature (25° C.) for at least 30 minutes. Subsequently, the carrier film was peeled off from the AR film. The Wa of the AR surface, which had been in contact with the adhesive surface, and the Wa of the adhesive surface of the carrier film were then measured, respectively, which are called Wa_{AR}1 and Wa1, respectively.

The arithmetic mean surface waviness (Wa) according to the invention was measured using the following method. The carrier film and the AR film were each bonded to a glass slide (S1214 manufactured by Matsunami Glass Ind., Ltd., 1.2 to 1.5 mm in thickness) with a double-coated adhesive tape (CS9621T manufactured by NITTO DENKO CORPORATION) in such a way that the surfaces to be measured (evaluated), specifically, the “adhesive surface” of the carrier film and the “AR surface”, were exposed. The Wa of the adhesive surface and the Wa of the AR surface were measured under the following conditions.

The meter used was an optical profiler NT9100 (manufactured by Veeco Instruments Inc.). The measurement conditions were as follows: measurement type, VSI (infinite scan); objective, 2.5×; FOV, 1.0×; modulation threshold, 1%; n=3.

After the measurement, data analysis was performed under the following conditions: Terms Removal: Tilt Only (Plane Fit); Window Filtering Fourier Filtering, in which the arithmetic mean surface waviness Wa was defined as the arithmetic mean surface roughness Ra obtained under the following conditions: Fourier Filtering, Low Pass; Fourier Filter Window: Gaussian, Low Cut off: 5/mm.

### Wa Change Rate

The rate (Wa1/Wa) of change in the Wa of the adhesive surface and the rate (Wa_{AR}1/Wa_{AR}) of change in the Wa of the AR surface before and after the bonding of the “adhesive surface” of the carrier film to the “AR surface” of the AR film were calculated from the measured values Wa, Wa1, Wa_{AR}, and Wa_{AR}1.

### Observation of the Surface Condition of Functional Layer

The AR film (anti-reflection film, product number: A-3504 manufactured by Nihon Ref-Lite Co., Ltd.) as the adherend was peeled off from the adhesive surface of the pressure-sensitive adhesive layer of the carrier film. Subsequently, the AR surface, which had been in contact with the adhesive surface of the carrier film, was visually observed under a fluorescent light, and it was determined whether or not there were irregularities on the AR surface.

⊙: No irregularities were observed on the AR surface.
◯: Few irregularities were observed on the AR surface.
X: Irregularities were clearly observed on the AR surface.

### Measurement of Adhesive Power

A 20 mm-wide, 100 mm-long, anti-reflection film (AR film) (product number: A-3504 manufactured by Nihon Ref-Lite Co., Ltd.) was fixed on a SUS plate (SUS 430BA) and used as an adherend. The adhesive surface of the carrier film was pressure-bonded to the AR film at a linear pressure of 78.5 N/cm and a rate of 0.3 m/minute. The resulting laminate was heated in an environment at 140° C. for 90 minutes and then allowed to stand at room temperature (25° C.) for at least 30 minutes. In the same environment, the carrier film was then peeled off from the AR film under the conditions of a peel angle of 180° and a peeling rate of 0.3 m/minute (low peeling rate) and a peeling rate of 10 m/minute (high peeling rate) using a universal tensile tester. In this test, the peel strength was measured and evaluated as the adhesive power (N/20 mm) to the AR film.

TABLE 1

| | | | Functional | Weight | |
|---|---|---|---|---|---|
| | | | group-containing | average | |
| Acrylic | Main monomer | | monomer | molecular | |
| polymer | BA | 2EHA | AA | weight (Mw) | Tg (° C.) |
| A | 95 | — | 5 | 600,000 | −50 |
| B | 90 | — | 10 | 750,000 | −45 |
| C | 60 | 40 | 3 | 1,010,000 | −59 |
| D | — | 100 | 4 | 550,000 | −66 |

Notes:
BA, butyl acrylate;
2EHA, 2-ethylhexyl acrylate;
AA, acrylic acid

TABLE 2

| | | | | | Molar ratio of the |
|---|---|---|---|---|---|
| | | | | | functional group B of the |
| | | | | | crosslinking agent to the |
| | Acrylic | | Crosslinking | | functional group A of the |
| | polymer | | agent | | raw material monomer (B is |
| Formulation | Type | Parts | Type | Parts | reactive with A) |
| Example 1 | A | 100 | T/C | 7 | 0.92 |
| Example 2 | B | 100 | T/C | 12 | 0.79 |
| Example 3 | C | 100 | T/C | 4 | 0.87 |
| Example 4 | B | 100 | T/C | 11 | 0.72 |
| Comparative | D | 100 | T/C | 4 | 0.65 |
| Example 1 | | | | | |

Notes:
Raw material monomer, acrylic acid (AA);
functional group A: carboxyl group,
T/C: an epoxy crosslinking agent (TETRAD-C manufactured by MITSUBISHI GAS CHEMICAL COMPANY, INC.),
functional group B: epoxy group, the molar ratio is expressed to two places of decimals.

TABLE 3

| | Adhesive surface of | | | | | | Surface | Adhesive power | |
|---|---|---|---|---|---|---|---|---|---|
| | carrier film | | | AR surface of AR film | | | condition of | (N/20 mm) to AR film | |
| | | | Wa change | | | Wa_{AR} change | functional | Peeling | Peeling |
| Evaluation | Wa | Wa1 | rate | Wa_{AR} | Wa_{AR}1 | rate | layer (AR | rate | rate |
| results | [nm] | [nm] | (Wa1/Wa) | [nm] | [nm] | (Wa_{AR}1/Wa_{AR}) | surface) | 0.3 m/min | 10 m/min |
| Example 1 | 32.82 | 49.38 | 1.5 | 25.58 | 26.12 | 1.0 | ⊙ | 0.51 | 3.30 |
| Example 2 | 43.61 | 46.16 | 1.1 | 25.58 | 38.06 | 1.5 | ⊙ | 0.53 | 0.40 |
| Example 3 | 51.30 | 55.51 | 1.1 | 25.58 | 55.99 | 2.2 | ◯ | 0.46 | 2.00 |
| Example 4 | 34.33 | 43.46 | 1.3 | 25.58 | 31.04 | 1.2 | ⊙ | 0.61 | 0.43 |
| Comparative | 236.91 | 138.8 | 0.6 | 25.58 | 115.05 | 4.5 | X | 0.45 | 2.40 |
| Example 1 | | | | | | | | | |

As shown from the results in Table 3, in all the examples where the arithmetic mean surface waviness Wa of the adhesive surface of the pressure-sensitive adhesive layer of the carrier film for transparent conductive films has been controlled to be within the desired range, the adhesive surface has been successfully prevented from having irregularities, so that the AR surface has also been successfully prevented from having irregularities and the appearance of the transparent conductive film has been successfully improved. In all the examples, the adhesive power has also been successfully controlled to be within the desired range at both low and high peeling rates, and the adhesive properties have also been found to be good.

In contrast, irregularities have been observed on the AR surface in Comparative Example 1 where the arithmetic mean surface waviness Wa of the adhesive surface of the carrier film for transparent conductive films is out of the desired range.

It has also been demonstrated that the same advantageous effect can be obtained also when an ITO thin film layer is formed on the PET film side of the AR film (anti-reflection film, product number: A-3504 manufactured by Nihon Ref-Lite Co., Ltd.) opposite to its side where the AR coating layer is formed.

### EXPLANATION OF REFERENCE NUMERALS

1a Transparent conductive layer
1b Support (base material)
1 Transparent conductive film
2 Functional layer
3 Pressure-sensitive adhesive layer
4 Support (base material)
10 Functional layer-bearing transparent conductive film
20 Carrier film for functional layer-bearing transparent conductive film
A Adhesive surface opposite to the surface in contact with the support

1. A carrier film for transparent conductive films, comprising:
a support; and
a pressure-sensitive adhesive layer provided on at least one side of the support,
wherein the pressure-sensitive adhesive layer has an adhesive surface with an arithmetic mean surface waviness Wa of 70 nm or less opposite to an adhesive surface in contact with the support.

2. The carrier film according to claim 1, wherein the pressure-sensitive adhesive layer is made from a pressure-sensitive adhesive composition containing a base polymer and a crosslinking agent.

3. The carrier film according to claim 2, wherein the base polymer is a (meth)acrylic polymer, and the pressure-sensitive adhesive composition contains more than 10 parts by weight of the crosslinking agent based on 100 parts by weight of the (meth)acrylic polymer.

4. The carrier film according to claim 2, wherein the base polymer is a (meth)acrylic polymer obtained by polymerization of a monomer component containing a (meth)acrylic ester having an alkyl group of 2 to 14 carbon atoms and a functional group-containing monomer.

5. The carrier film according to claim 4, wherein a molar ratio of a functional group of the crosslinking agent to a functional group of the functional group-containing monomer is 0.70 or more.

6. The carrier film according to claim 4, wherein the (meth)acrylic ester includes butyl (meth)acrylate.

7. A laminate, comprising:
a carrier film for transparent conductive films; and
a transparent conductive film placed on the carrier film,
wherein
the carrier film is a carrier film according to claim 1,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

8. A laminate, comprising:
a carrier film for transparent conductive films; and
a transparent conductive film placed on the carrier film,
wherein
the carrier film is a carrier film according to claim 1,
the transparent conductive film comprises a support, a transparent conductive layer, and a functional layer provided on a surface of the support opposite to a surface of the support in contact with the transparent conductive layer, and
an adhesive surface of the pressure-sensitive adhesive layer of the carrier film is bonded to a surface of the functional layer opposite to a surface of the functional layer in contact with the support.

9. The laminate according to claim 8, which has a ratio of Wa after bonding to Wa before bonding of 0.5 to 3.0, wherein Wa after bonding represents the arithmetic mean surface waviness of a surface of the functional layer of the transparent conductive film after the surface is brought into contact with and bonded to the adhesive surface of the pressure-sensitive adhesive layer of the carrier film, and Wa before bonding represents the arithmetic mean surface waviness of the surface of the functional layer of the transparent conductive film before the surface is brought into contact with and bonded to the adhesive surface of the pressure-sensitive adhesive layer of the carrier film.

10. The carrier film according to claim 3, wherein the base polymer is a (meth)acrylic polymer obtained by polymerization of a monomer component containing a (meth)acrylic ester having an alkyl group of 2 to 14 carbon atoms and a functional group-containing monomer.

11. The carrier film according to claim 5, wherein the (meth)acrylic ester includes butyl (meth)acrylate.

12. A laminate, comprising:
a carrier film for transparent conductive films; and
a transparent conductive film placed on the carrier film,
wherein
the carrier film is a carrier film according to claim 2,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

13. A laminate, comprising:
a carrier film for transparent conductive films; and
a transparent conductive film placed on the carrier film,
wherein
the carrier film is a carrier film according to claim 3,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

14. A laminate, comprising:
a carrier film for transparent conductive films; and
a transparent conductive film placed on the carrier film,
wherein
the carrier film is a carrier film according to claim 4,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

15. A laminate, comprising:
a carrier film for transparent conductive films; and
a transparent conductive film placed on the carrier film,
wherein
the carrier film is a carrier film according to claim 5,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

16. A laminate, comprising:
a carrier film for transparent conductive films; and
a transparent conductive film placed on the carrier film,
wherein
the carrier film is a carrier film according to claim 6,
the transparent conductive film comprises a support and a transparent conductive layer, and
an adhesive surface of the pressure-sensitive adhesive layer of the carrier film is bonded to a surface of the support opposite to a surface of the support in contact with the transparent conductive layer.

17. A laminate, comprising:
a carrier film for transparent conductive films; and
a transparent conductive film placed on the carrier film,
wherein
the carrier film is a carrier film according to claim 2,
the transparent conductive film comprises a support, a transparent conductive layer, and a functional layer provided on a surface of the support opposite to a surface of the support in contact with the transparent conductive layer, and
an adhesive surface of the pressure-sensitive adhesive layer of the carrier film is bonded to a surface of the functional layer opposite to a surface of the functional layer in contact with the support.

18. A laminate, comprising:
a carrier film for transparent conductive films; and
a transparent conductive film placed on the carrier film,
wherein
the carrier film is a carrier film according to claim 3,
the transparent conductive film comprises a support, a transparent conductive layer, and a functional layer provided on a surface of the support opposite to a surface of the support in contact with the transparent conductive layer, and
an adhesive surface of the pressure-sensitive adhesive layer of the carrier film is bonded to a surface of the functional layer opposite to a surface of the functional layer in contact with the support.

19. A laminate, comprising:
a carrier film for transparent conductive films; and
a transparent conductive film placed on the carrier film,
wherein
the carrier film is a carrier film according to claim 4,
the transparent conductive film comprises a support, a transparent conductive layer, and a functional layer provided on a surface of the support opposite to a surface of the support in contact with the transparent conductive layer, and
an adhesive surface of the pressure-sensitive adhesive layer of the carrier film is bonded to a surface of the functional layer opposite to a surface of the functional layer in contact with the support.

20. A laminate, comprising:
a carrier film for transparent conductive films; and
a transparent conductive film placed on the carrier film,
wherein
the carrier film is a carrier film according to claim 5,
the transparent conductive film comprises a support, a transparent conductive layer, and a functional layer provided on a surface of the support opposite to a surface of the support in contact with the transparent conductive layer, and
an adhesive surface of the pressure-sensitive adhesive layer of the carrier film is bonded to a surface of the functional layer opposite to a surface of the functional layer in contact with the support.
